(19) United States
(12) Patent Application Publication
(10) Pub. No.: US 2003/0126423 A1
(43) Pub. Date: Jul. 3, 2003

(54) Electronic branding technology

(75) Inventor: William H. Moody II, Austin, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(73) Assignee: Crossroads Systems, Inc., Austin, TX

(21) Appl. No.: 09/683,428

(22) Filed: Dec. 28, 2001

(51) Int. Cl. G06F 15/177; G06F 11/30; H02H 3/05

(52) U.S. Cl. 713/2; 713/200; 714/1

(57) ABSTRACT

Systems and methods for identifying brands of electronic components and enabling a primary electronic system to make use of only those components which are identified as having the same brand as the primary system. In a preferred embodiment, each of a primary component and one or more secondary components includes a non-volatile memory for storing a brand identifier. Upon boot-up of the primary component, the identifier in the memory of each secondary component is compared to the identifier in the memory of the primary component. Secondary components having identifiers that match the identifier of the primary component are enabled and those having identifiers that do not match the identifier of the primary component are disabled.

### BACKGROUND OF INVENTION

Electronic equipment such as network routers periodically require installation of new modules or subcomponents. This may be necessary in order to maintain or repair the equipment, or to provide updated hardware or firmware. The purchasers of the equipment may look to various sources for the replacement modules. For example, they may get the modules from the companies who originally sold the equipment to them, or they may shop for a more inexpensive supplier of the same modules.

Obviously, the supplier that originally sells the equipment to the customer would prefer that the customer also buy replacement modules from that supplier. The supplier also wants to accomplish this without having to drastically reduce its prices. If another supplier has lower prices on the modules, the first supplier must find an alternative way to retain the customer's business.

One way of retaining the customer”s business is by ensuring that only modules purchased from the same supplier can be used with the equipment. Modules purchased from other suppliers must somehow be prevented from operating with the original supplier's equipment. One way to accomplish this is through the use of unique physical interfaces in the equipment. For instance, the first supplier may use a unique connector in the equipment which is compatible only with modules sold by the original supplier. If the customer purchases a module from another supplier, the module simply cannot be connected and consequently cannot be used.

The use of unique physical interfaces, however, is not always an ideal solution to the customer retention problem. For instance, in situations where equipment is produced by a single manufacturer and distributed through several suppliers (original equipment manufacturers, or OEMS) as their own product, the manufacturer may provide different physical interfaces for the components of each of the OEMs. Each OEM then supplies its customers with equipment that incorporates its own unique interface. As a result of the need to manufacture the same equipment with different physical interfaces, the cost of manufacturing the equipment may increase substantially. It would therefore be desirable to provide a means for controlling the interoperability of the originally purchased equipment and subsequently purchased modules.

### SUMMARY OF INVENTION

One or more of the problems outlined above may be solved by the various embodiments of the invention. Broadly speaking, the invention comprises systems and methods for identifying brands of electronic components and enabling a primary electronic system to make use of only those components which are identified as having the same brand as the primary system.

In one embodiment, each of a plurality of electrical components has a memory which is configured to store a brand identifier. The components are configured to be coupled together and are designed to interoperate with each other. A first one of the components has a data processor configured to receive the identifier stored in each component”s memory and to determine, based upon this identifier, whether the corresponding component is authorized to be used in conjunction with the first component. If the components are authorized to be used together, operation of the components with each other is enabled. Otherwise, the first component will operate without the second component.

In a preferred embodiment, the invention is implemented in a storage router. The router has a non-volatile memory which stores a brand identifier. One or more modules which are designed to be interoperable with the router also include nonvolatile memories which store corresponding brand identifiers for the respective modules. The router and modules are coupled together by a PCI bus and an I² C bus. The PCI bus is configured to allow the router to communicate operational data to and from those modules which are enabled so that they can interoperate with the router. The I² C bus is connected to all of the modules and allows the router to poll each module for the corresponding brand identifier. The router is configured to compare the identifier for each module to its own identifier and, for those modules having identifiers which are identical to the identifier of the router, the modules are enabled. For those modules which do not have identifiers which are identical to the identifier of the router, the modules are disabled.

Numerous additional embodiments are also possible.

### BRIEF DESCRIPTION OF DRAWINGS

Other objects and advantages of the invention may become apparent upon reading the following detailed description and upon reference to the accompanying drawings.

FIG. 1 is a flow diagram illustrating a method in accordance with one embodiment of the present invention.

FIG. 2 is a functional block diagram illustrating the components of a system in accordance with one embodiment of the present invention.

FIG. 3 is a detailed flow diagram illustrating a method in accordance with one embodiment of the present invention.

FIG. 4 is a functional block diagram illustrating the components of a system in accordance with one embodiment of the present invention.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION

Broadly speaking, the invention comprises systems and methods for identifying electronic components and enabling a primary electronic system to make use of only those components which are identified as having the same brand as the primary system.

In a preferred embodiment, a non-volatile memory is included in the design of a primary electronic system or component, such as a storage router designed for use in communicating data between Fibre Channel and SCSI devices. The non-volatile memory is designed to store an identifier corresponding to the OEM that distributes the system. A number of secondary components or modules which are designed to be interoperable with the primary component are also manufactured with a non-volatile memory which is configured to store an identifier associated with an OEM. The primary and secondary components, which may be manufactured either by a single manufacturer or by multiple manufacturers, store in their respective nonvolatile memories the identifiers of the OEMs that distributed them.

Generally, the system operates as follows. One or more of the secondary components is coupled to the primary system. The primary system identifies the components as having been coupled to the system and then polls each of the components for their respective identifiers. That is, it reads the identifier from the non-volatile memory of each of the connected components. Each of these identifiers is compared to the identifier stored in the non-volatile memory of the primary system. If the identifier for a component matches the identifier stored in the primary system, then that component is enabled by the primary system. If the identifier for a component does not match the identifier of the primary system, then that component is disabled. After each of the components has been checked and either enabled or disabled, the primary system begins normal operation with the enabled components. The disabled components are treated by the primary system as if they were not coupled to it.

As will be described in more detail below, the preferred embodiment does not allow components to be hot-swapped (coupled to the system while it is powered up). In this embodiment, the system is powered down, then the components are connected to it, then the system is powered up. The system then polls the components as part of its boot procedures. It should be noted, however, that other embodiments of the invention may be implemented in systems which allow hot-swapping of components. In such systems, the polling of the components for their identifiers will be performed as part of the initialization procedures for the hot-swapped components (and possibly also as part of the system boot procedures).

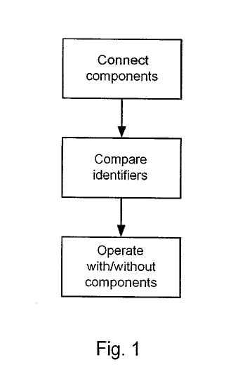

Referring to FIG. 1, a flow diagram illustrating a method in accordance with a basic embodiment of the present invention is shown. In this embodiment, the method has three basic steps: connection of a first component to a second component; retrieval of identifiers stored in memories in each of the components; comparison of the identifiers; and operation of the second component, either with or without the first component, depending upon the results of the comparison of their identifiers.

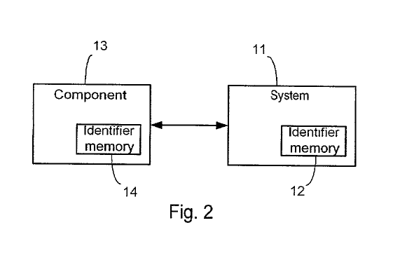

Referring to FIG. 2, a functional block diagram illustrating the components of a system in accordance with a basic embodiment of the present invention is shown. In this embodiment, a primary system 11 includes a memory 12 to store an identifier associated with it. A component 13 is configured to be coupled to primary system 11 and operated in conjunction with the primary system. Component 13 has a memory 14 included therein for storing an identifier associated with the component. When primary system 11 and component 13 are coupled together, component 13 is configured to provide the identifier stored in memory 14 to primary system 11. Primary system 11 is configured to compare the identifier received from component 13 to the identifier stored in its own memory (12). If comparison of the two identifiers indicates that component 13 is authorized to be used with primary system 11, the primary system enables use of the component. Otherwise, primary system 11 operates as if component 13 is not available to it.

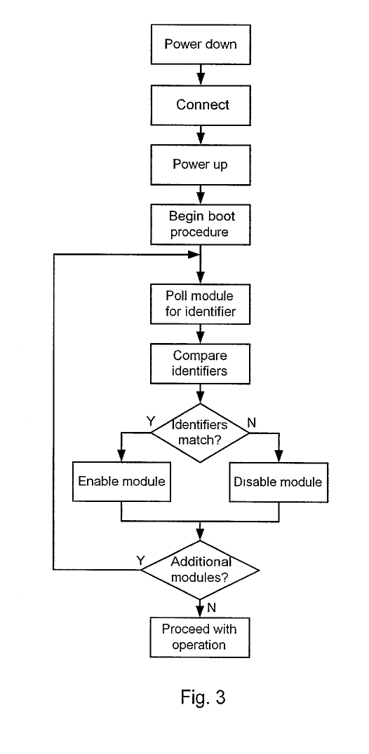

Referring to FIG. 3, a somewhat more detailed flow diagram illustrating a method in accordance with another embodiment of the present invention is shown. As shown in this figure, a module is coupled to a device, or primary system. The primary system may, for example, be a device such as a storage router, while the module may be a Fibre Channel interface module, an LVD SCSI interface module, an HVD SCSI module, an iSCSI interface module, or any other module that may be connected to the device. In this embodiment, the primary system is powered down prior to connecting the module to it. (As noted above, provisions may be made for connection of the module while the primary system is powered up in other embodiments.) When the primary system is powered up, it executes a boot-up routine. As part of this routine, modules which are connected to the system are polled for corresponding OEM identifiers which are stored in non-volatile memories within the modules. Each of the OEM identifiers retrieved from the modules is compared to an OEM identifier of the primary system. This identifier is stored in a non-volatile memory onboard the primary system.

For each module whose identifier matches that of the primary system, the use of the module is presumed to be authorized. Conversely, if the identifier of a module does not match that of the primary system, it is presumed that the use of the corresponding module is not authorized. After determining which of the modules are authorized for use and which are not, the primary system proceeds to enable the authorized modules and disable the unauthorized modules. Operation of the primary system then continues normally with the enabled modules.

It should be noted that, although the embodiment described in detail herein performs a comparison of the OEM identifiers stored by each of the components and determines them to be authorized if the identifiers are an exact match, the comparison may be performed differently in other embodiments. For example, the identifier stored in the memory of the secondary component may be compared to the identifiers of several authorized OEMs. If the identifier of the secondary component matches the identifier of any one of these authorized OEMs, it may be enabled. Other such variations may also be possible and are contemplated to be within the scope of this disclosure.

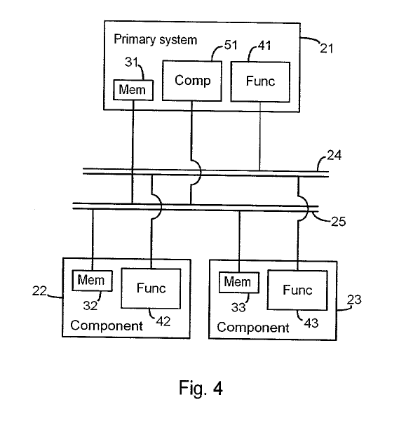

Referring to FIG. 4, the modules or subcomponents of the preferred embodiment are each shown coupled to the primary system. For the purposes of the description that follows, both primary system 21 and subcomponents 22 and 23 will be referred to as “components”of the system. It should be noted that the identification of one of the components as “primary” is not important, except to the extent that the primary component is normally responsible for comparison of the identifiers and configuration of the components to allow them to operate in conjunction with each other. Likewise, throughout this disclosure, the terms primary system, system, component, subcomponent, module, and the like are generally interchangeable, except as otherwise indicated by the context in which they are used.

The components are, in this embodiment, coupled together by two separate buses. The first bus 24 is a PCI bus which is coupled to the functional block (41, 42, 43) of each of the components. This is the pathway over which data is transferred between the components during normal operation of the system. As indicated above, however, each of components 22 and 23 must be configured by system 21 to enable them to communicate with the system via PCI bus 24.

Components 21-23 are also coupled together via Inter-IC (“I² C”) bus 25. I² C bus 25 is a very simple serial bus which is designed to enable very basic communications between the modules without having to first configure the modules for operation with the system. When the components are physically coupled to the system, I² C bus 25 is operable. Functionally, I² C bus 25 is coupled to each of the components so that their respective non-volatile memories (31-33), and the OEM identifiers stored therein, can be accessed. FIG. 4 also shows comparator 51 coupled to I² C bus 25. Comparator 51 comprises a data processor. This processor may be the same processor which also provides some or all of the functionality of functional block 41. Comparator 51 is configured to compare the identifiers retrieved from memories 31-33 and to determine which of components 22 and 23 is authorized for use with component 21. Based upon this determination, the system is configured to enable the authorized components.

In the preferred embodiment, component 21 is configured to poll all of the modules which are present (in this instance, components 22 and 23) via I² C bus 25 during the boot-up of the system. Although only two secondary components (22 and 23) are depicted in the figure, other secondary components can be coupled to primary component 21 in the same manner. Any combination of the connected components may be enabled to operate with primary component 21, depending upon the outcome of the identifier comparison. After the boot-up process is complete and operation of the system begins, those components that were not identified as being authorized are not enabled and will not be used by the system.

In the preferred embodiment, the OEM identifier is simply a character string. The string may be of essentially any length, although longer strings (or values, if values are used as identifiers) can obviously be used to distinguish between a larger number of alternative OEMs. It should also be noted that the use of the identifier need not be limited to OEMs and may identify particular distributors or groups of distributors, specific contracts, or any other information which might be used as the basis for determining whether or not to enable operation of the components.

In the preferred embodiment, the identifier is stored in a non-volatile memory. A non-volatile memory is used because the preferred embodiment is intended to store the OEMs of the respective components (as well as the primary system). This information does not change and needs to be retained in the memory even if there is no power to the components (and/or system). Nevertheless, it is contemplated that a volatile memory could be used. This would, however, create a risk that the identifier could be lost (e.g., if the power to the volatile memory failed). Since the loss of the identifier would prevent identification of the components' OEMs, the preferred embodiment uses the non-volatile memory in both the primary system and the components.

In the preferred embodiment, the primary system is configured to poll each component for the identifier stored in its memory. This may be accomplished by querying the components for their respective identifiers, by reading the identifiers directly from the memories (which would have to be accessible to the primary system), or by any other suitable means.

The component memories are polled during boot up in the preferred embodiment. The polling procedure is contained in the bios of the primary system so that it is performed whenever the system is powered up. The system may therefore be considered plug-and-play, but it is not hot-pluggable. In other embodiments, the polling procedures may be contained in operational software which polls components that are hot-plugged into the primary system.

While the foregoing description relates to an embodiment of the invention which is implemented in hardware, it is contemplated that other embodiments may comprise software applications which are configured to perform the same or similar functions as the described embodiment. Such software applications and media (e.g., floppy disks, CD-ROMs, DVD-ROMs, etc.) which contain such applications are considered to be within the scope of this disclosure.

The benefits and advantages which may be provided by the present invention have been described above with regard to specific embodiments. These benefits and advantages, and any elements or limitations that may cause them to occur or to become more pronounced are not to be construed as a critical, required, or essential features of any or all of the claims. As used herein, the terms “comprises,” “comprising,” or any other variations thereof, are intended to be interpreted as nonexclusively including the elements or limitations which follow those terms. Accordingly, a process, method, article, or apparatus that comprises a list of elements does not include only those elements but may include other elements not expressly listed or inherent to the claimed process, method, article, or apparatus.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method comprising:
providing a primary electronic component having a first identifier stored therein;
providing a secondary electronic component having a second identifier stored therein;
coupling the secondary component to the primary component;
comparing the first identifier to the second identifier; operating the primary component in conjunction with the secondary component if the first identifier matches the second identifier; and
operating the primary component without the secondary component if the first identifier does not match the second identifier.

2. The method of claim 1, further comprising storing the first identifier in a memory in the primary component and storing the second identifier in a memory in the secondary component.

3. The method of claim 2, wherein the first and second identifiers are stored in non-volatile memories.

4. The method of claim 1, wherein coupling the secondary component to the primary component comprises coupling the secondary component to the primary component via a first interconnect which is configured to transfer data between the secondary component and the primary component during normal operation and via a second interconnect which is configured to transfer data between the secondary component and the primary component for the purposes of comparing the first identifier to the second identifier.

5. The method of claim 4, wherein the first interconnect is a PCI bus.

6. The method of claim 1, further comprising enabling the secondary component if the first identifier matches the second identifier; and disabling the secondary component if the first identifier does not match the second identifier.

7. The method of claim 1, wherein comparing the first identifier to the second identifier is performed during boot-up.

8. The method of claim 1, further comprising providing at least one additional electronic secondary component having an additional identifier stored therein.

9. The method of claim 8, further comprising coupling the additional secondary component to the primary component.

10. The method of claim 9, further comprising comparing the first identifier to the additional identifier.

11. The method of claim 10, further comprising operating the primary component in conjunction with the additional secondary component if the first identifier matches the additional identifier.

12. The method of claim 11, further comprising operating the primary component without the additional secondary component if the first identifier does not match the additional identifier.

13. A system comprising:
a primary component having a first memory, wherein the first memory has a first identifier stored therein; and
a secondary component having a second memory, wherein the second memory has a second identifier stored therein;
wherein the secondary component is configured to be coupled to the primary component;
wherein the primary component is configured to compare the first identifier to the second identifier;
wherein the primary component is configured to enable operation with the secondary component if the first identifier matches the second identifier;
wherein the primary component is configured to prevent operation with the secondary component if the first identifier does not match the second identifier.

14. The system of claim 13, wherein at least one of the first and second memories comprises a non-volatile memory.

15. The system of claim 13, wherein the secondary component is configured to be coupled to the primary component by a first interconnect, wherein if the primary component is enabled to operate with the secondary component, data is transferred between the primary component and the secondary component via the first interconnect during operation.

16. The system of claim 15, wherein the first interconnect comprises a PCI bus.

17. The system of claim 15, wherein the secondary component is further configured to be coupled to the primary component by a second interconnect, wherein the primary component is configured to receive the second identifier via the second interconnect.

18. The system of claim 17, wherein the second interconnect comprises an Inter-IC (I² C) bus.

19. The system of claim 13, wherein the primary component comprises a storage router.

20. The system of claim 19, wherein the secondary component is selected from the group consisting of: a Fibre Channel interface module; an LVD SCSI interface module; an HVD SCSI module; and an iSCSI interface module.

21. An electrical component configured to have a secondary component coupled thereto, wherein the electrical component comprises:
a functional portion;
an interface configured to couple the functional portion to a secondary component;
a memory configured to store a first identifier; and
a comparator configured to receive a second identifier from the secondary component and to compare the first identifier to the second identifier, wherein the comparator is configured to enable operation of the functional portion with the secondary component if the first identifier matches the second identifier and to disable operation of the functional portion with the secondary component if the first identifier does not match the second identifier.

22. The electrical component of claim 21, wherein the memory comprises a nonvolatile memory.

23. The electrical component of claim 21, wherein the interface comprises a PCI bus.

24. The electrical component of claim 21, wherein the functional portion comprises a storage router.

25. The electrical component of claim 21, further comprising a serial bus configured to be coupled to the secondary component, wherein the electrical component is configured to receive the second identifier via the serial bus.

26. The electrical component of claim 25, wherein the serial bus comprises an Inter-IC (I² C) bus.
